(19) United States
(12) Patent Application Publication
(10) Pub. No.: US 2020/0267071 A1
(43) Pub. Date: Aug. 20, 2020

(54) TRAFFIC FOOTPRINT CHARACTERIZATION

(71) Applicant: VMware, Inc., Palo Alto, CA (US)

(72) Inventor: Aditi Ghag, Palo Alto, CA (US)

(73) Assignee: VMware, Inc., Palo Alto, CA (US)

(21) Appl. No.: 16/277,576

(22) Filed: Feb. 15, 2019

(51) Int. Cl. H04L 12/26

(52) U.S. Cl. CPC H04L 43/0882; H04L 43/16

(57) ABSTRACT

A method for traffic footprint characterization can include monitoring containerized workloads originating from a virtual computing instance (VCI) and/or container. The method can further include determining that a containerized workload originating from the VCI consumes greater than a threshold amount of bandwidth and tagging the VCI in response to determining that the containerized workload consumes greater than the threshold amount of bandwidth.

### BACKGROUND

Virtual computing instances (VCIs), such as virtual machines, virtual workloads, data compute nodes, clusters, and containers, among others, have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. VCIs can be deployed on a hypervisor provisioned with a pool of computing resources (e.g., processing resources, memory resources, etc.). There are currently a number of different configuration profiles for hypervisors on which VCIs may be deployed.

### BRIEF DESCRIPTION OF THE DRAWINGS

FIG. 1 is a diagram of a host for traffic footprint characterization according to the present disclosure.

FIG. 2 is a diagram of a simplified system for traffic footprint characterization according to the present disclosure.

FIG. 3A is a diagram of a system including a scheduling agent, virtual computing instances, and hypervisors for traffic footprint characterization according to the present disclosure.

FIG. 3B is a diagram of a system including a traffic footprint characterization agent, virtual computing instances, and hypervisors for traffic footprint characterization according to the present disclosure.

FIG. 3C is another diagram of a system including a scheduling agent, virtual computing instances, and hypervisors for traffic footprint characterization according to the present disclosure.

FIG. 4A is a flow diagram representing a method for traffic footprint characterization according to the present disclosure.

FIG. 4B is another flow diagram representing a method for traffic footprint characterization according to the present disclosure.

FIG. 5 is a diagram of a system for traffic footprint characterization according to the present disclosure.

FIG. 6 is a diagram of a machine for traffic footprint characterization according to the present disclosure.

### DETAILED DESCRIPTION

The term “virtual computing instance” (VCI) covers a range of computing functionality. VCIs may include data compute nodes such as virtual machines (VMs). Containers can run on a host operating system without a hypervisor or separate operating system, such as a container that runs within Linux. A container can be provided by a virtual machine that includes a container virtualization layer (e.g., Docker). A VM refers generally to an isolated end user space instance, which can be executed within a virtualized environment. Other technologies aside from hardware virtualization can provide isolated end user space instances may also be referred to as VCIs. The term “VCI” covers these examples and combinations of different types of VCIs, among others.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VM segregation that may be offered in hypervisor-virtualized environments that virtualize system hardware, and thus can be viewed as a form of virtualization that isolates different groups of applications that operate in different containers. Such containers may be more “lightweight” than VMs at least because they share an operating system rather than operating with their own guest operating system.

Multiple VCIs can be configured to be in communication with each other in a software defined data center. In such a system, information can be propagated from an end user to at least one of the VCIs in the system, between VCIs in the system, and/or between at least one of the VCIs in the system and a non-virtualized physical host.

Software defined data centers are dynamic in nature. For example, VCIs and/or various application services, may be created, used, moved, or destroyed within the software defined data center. When VCIs are created (e.g., when a container is initialized), various processes and/or services start running and consuming resources. As used herein, “resources” are physical or virtual components that have a finite availability within a computer or software defined data center. For example, resources include processing resources, memory resources, electrical power, and/or input/output resources, etc.

Containerized cloud-native applications can be used to accelerate application delivery in software defined data centers. As used herein, “containerized” or “containerization” refers to a virtualization technique in which an application (or portions of an application, such as flows corresponding to the application) are encapsulated into a container (e.g., Docker, Linux containers, etc.) as an alternative to full machine virtualization. Because containerization can include loading the application on to a VCI, the application may be run on any suitable physical machine without worrying about application dependencies. Further, as used herein, “cloud-native applications” refer to applications (e.g., computer programs, software packages, etc.) that are assembled as containerized workloads (e.g., microservices) in containers deployed in a software defined data center. “Containerized workloads” or “microservices” refer to a computing architecture in which an application is structured as a collection of loosely coupled (e.g., containerized) services. Containerized workload architectures may allow for improved application modularity, scalability, and continuous deployment in comparison to traditional application development environments.

In order to take advantage of the perceived benefits of containerized cloud-native applications, container schedulers such as KUBERNETES®, DOCKER SWARM®, MESOS®, etc. can be used to deploy and/or manage containerized applications. Container schedulers can consider parameters associated with the software defined data center on which they operate to deploy and/or manage the containerized applications. In some approaches, the parameters considered by the container scheduler can include host VCI resources (e.g., host VCI processing resources and/or memory resources), host VCI processing resource and/or memory resource utilization, and/or policy-based affinity rules (e.g., policy-based rules that can control the placement of VCIs and/or containers on host machines within a virtual cluster) as part of scheduling deployment and/or managing containers. This may be sub-optimal as the requirements of software defined data centers continue to expand.

For example, software defined data centers currently host a wide spectrum of applications with different needs, and therefore disparate application performance requirements. As the use of software defined data centers continues to increase, the spectrum of applications hosted on software defined data centers will continue to increase, further emphasizing the disparate performance requirements of the applications. For example, due to the dynamic nature of applications deployed in a software defined data center (e.g., applications running on VCIs, computers, etc. of the software defined data center), resource requirements of the applications may evolve over time, which can lead situations in which some approaches fail to adequately address evolving application performance requirements.

In order to address the dynamic nature of applications hosted on software defined data centers, embodiments disclosed herein can allow for a traffic footprint characterization agent and/or a container scheduler to consider characteristics of the traffic footprint of a software defined data center (SDDC) when scheduling containers and/or containerized workloads. For example, a method for traffic footprint characterization can include monitoring containerized workloads originating from a virtual computing instance (VCI) and/or container. The method can further include determining that a containerized workload originating from the VCI consumes greater than a threshold amount of bandwidth and tagging (e.g., assigning a tag to) the VCI in response to determining that the containerized workload consumes greater than the threshold amount of bandwidth.

Other embodiments can include monitoring, via a traffic footprint characterization agent deployed in a virtual computing cluster (VCC), network traffic originating from a computing instance deployed in the VCC and determining that a flow corresponding to a containerized workload originating from the computing instance includes greater than a threshold quantity of data and/or consumes greater than a threshold amount of bandwidth. In some embodiments, traffic footprint characterization can further include assigning, by the traffic footprint characterization agent, an indication to the containerized workload based, at least in part, on the determination that the flow corresponding to the containerized workload originating from the computing instance includes greater than the threshold quantity of data and/or consumes greater than a threshold amount of bandwidth.

As used herein, designators such as “N,” “M,” “X,” “Y,” “Z,” etc., particularly with respect to reference numerals in the drawings, indicate that a number of the particular feature so designated can be included. It is also to be understood that the terminology used herein is for the purpose of describing particular embodiments only, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

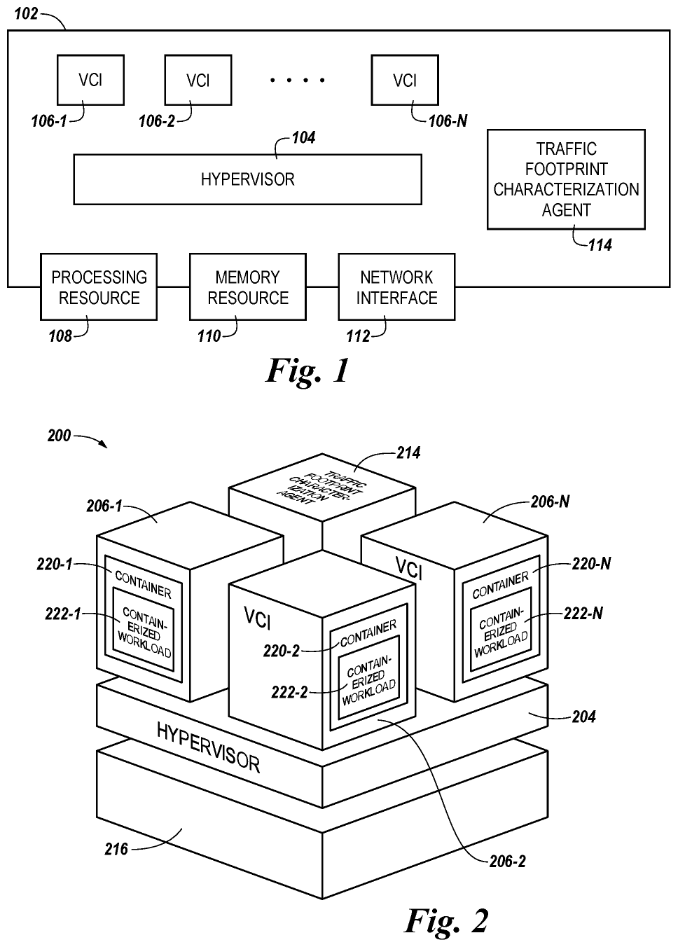

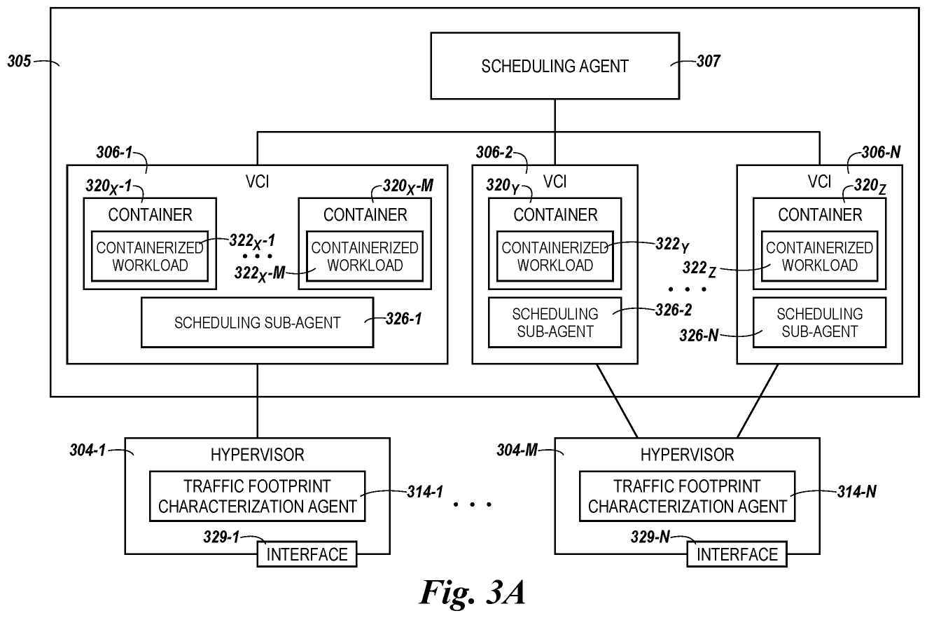

The figures herein follow a numbering convention in which the first digit or digits correspond to the drawing figure number and the remaining digits identify an element or component in the drawing. Similar elements or components between different figures may be identified by the use of similar digits. For example, 106 may reference element “06” in FIG. 1, and a similar element may be referenced as 206 in FIG. 2. A group or plurality of similar elements or components may generally be referred to herein with a single element number. For example, a plurality of reference elements 106-1, 106-2, . . . , 106-N may be referred to generally as 106. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments and should not be taken in a limiting sense.

Embodiments of the present disclosure are directed to traffic footprint characterization, for example, in the context of a software defined data center (e.g., a distributed computing environment) including one or more VCIs and/or containers. As described above, “containerized workloads” (e.g., microservices) refer to containerized instructions that correspond to portions of an application and are structured as a collection of loosely coupled (e.g., containerized) services. Containerized workloads can be created using different coding languages (e.g., as part of a polyglot approach to application deployment). For example, in a containerized workload or microservice architecture, an application can be divided into multiple modular services that can be deployed on containers. The containerized workloads can run fine-grained services, and the containers can have short lifespans. As used herein, “fine-grained services” refer to services that make direct use of resources that are granted direct access by one or more application programming interfaces (APIs). In contrast, “coarse-grained services” include services that utilize multiple fine-grained services. Further, as used herein, a “short lifespan” refers to a container that is destroyed after a short period of time (e.g., seconds to minutes), as compared to “long lifespan” containers, which operate for minutes or more before being destroyed. In some embodiments, short lifespan containers are containers that run containerized workloads, which are generally destroyed after a relatively short period of time once the containerized workload has been executed and consumed by an application.

Due to the short-lived nature of containers on which containerized workloads are deployed, haphazard scheduling of the containerized workloads can incur unwanted latencies in application execution. For example, latencies associated with application execution can exceed desirable thresholds, which can reduce the efficacy of a software defined data center. In addition, network latencies and/or throughput between individual containerized workloads can affect performance of an application that is associated with the containerized workloads.

Embodiments herein may allow for improved scheduling of containerized workloads which can lead to improved performance of a computing system such as a software defined data center, virtual computing cluster, server, or other computing device. For example, by scheduling containerized workloads in accordance with the embodiments described herein, applications can be assembled from containerized workloads more efficiently than in some approaches, which can reduce an amount of computing resources and/or an amount of time required to execute the application. This can lead to reduced downtime, quicker application execution, and/or improved user experience.

FIG. 1 is a diagram of a host 102 for traffic footprint characterization according to the present disclosure. The host 102 can be provisioned with processing resource(s) 108 (e.g., one or more processors), memory resource(s) 110 (e.g., one or more main memory devices and/or storage memory devices), and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 102 can incorporate a hypervisor 104 that can execute a number of VCIs 106-1, 106-2, . . . , 106-N (referred to generally herein as “VCIs 106”). The VCIs can be provisioned with processing resources 108 and/or memory resources 110 and can communicate via the network interface 112. The processing resources 108 and the memory resources 110 provisioned to the VCIs 106 can be local and/or remote to the host 102 (e.g., the VCIs 106 can be ultimately executed by hardware that may not be physically tied to the VCIs 106). For example, in a software defined data center, the VCIs 106 can be provisioned with resources that are generally available to the software defined data center and are not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106. In some embodiments, the host 102 can be connected to (e.g., in communication with) a traffic footprint characterization agent 114, which can be deployed on a VCI 106.

The VCIs 106-1, . . . , 106-N can include one or more containers (e.g., containers 220 illustrated in FIG. 2, herein), which can have a containerized workload (e.g., the containerized workloads 222 illustrated in FIG. 2, herein), such as a microservice, running thereon. The containerized workloads can correspond to one or more applications or portions of applications executed by the VCIs 106 and/or the host 102. The application may be configured to perform certain tasks and/or functions for the VCIs 106 and/or the host 102. By executing the application using multiple containerized workloads, scalability and/or portability of applications may be improved in comparison to approaches in which applications are monolithic.

In some embodiments, information generated by, or determined by, the traffic footprint characterization agent 114 can be used to schedule and/or coordinate container and/or containerized workload deployment across the VCIs 106, as described in more detail, herein. In some embodiments, the traffic footprint characterization agent 114 can be deployed on (e.g., may be running on) the host 102, and/or one or more of the VCIs 106. As used herein, an “agent” is a computing component configured to run at least one piece of software that is configured to perform actions without additional outside instruction. For example, an agent can be configured to execute instructions using computing resources, such as hardware, that can be available to the agent in the pool of computing resources.

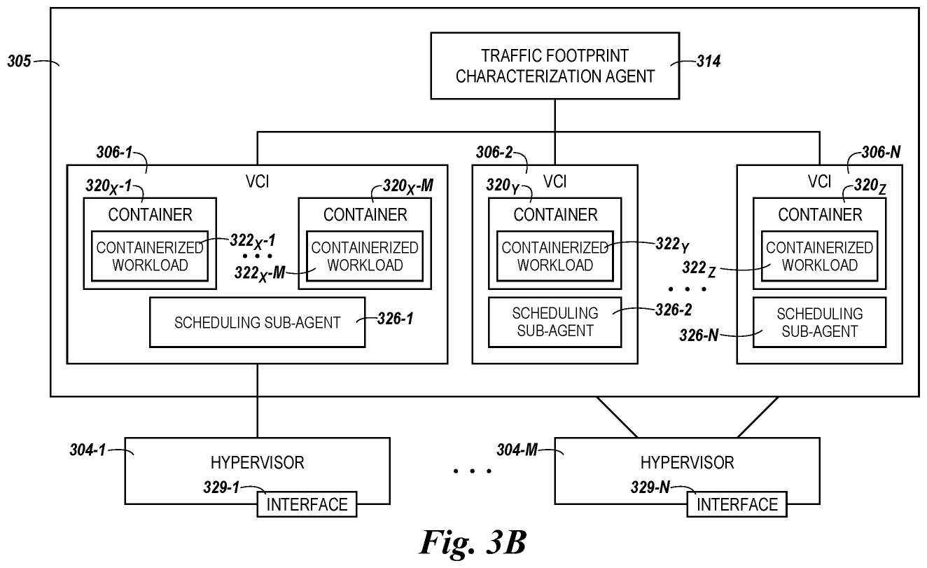

As described in more detail herein, the information generated by, or determined by, the traffic footprint characterization agent 114 can be used to schedule container and/or containerized workload deployment for the VCIs 106, the host 102, and/or a computing cluster (e.g., the virtual computing cluster (VCC) 305 illustrated in FIG. 3) in which the VCIs 106 and/or containers are deployed. For example, the information generated by or determined by the traffic footprint characterization agent 114 can be provided to a scheduling agent, such as the scheduling agent 307 illustrated in FIGS. 3A and 3C, herein to schedule container and/or containerized workload deployment. Non-limiting examples of a scheduling agent can include a container scheduler such as KUBERNETES®, DOCKER SWARM®, MESOS®, etc.

In some embodiments, the traffic footprint characterization agent 114 can include a combination of software and hardware, or the traffic footprint characterization agent 114 can include software and can be provisioned by processing resource 108. The traffic footprint characterization agent 114 can monitor containerized workloads originating from the VCIs 106. The traffic footprint characterization agent 114 can determine that a containerized workload originating from at least one of the VCIs 106 is consuming greater than a threshold amount of bandwidth (e.g., the containerized workload has greater than a threshold quantity of data associated therewith, is executed for greater than a threshold period of time, etc.). For example, the traffic footprint characterization agent 114 can determine that a traffic flow corresponding to the containerized workload is consuming greater than a threshold amount of bandwidth. The traffic footprint characterization agent 114 can tag the containerized workload with an indication that the containerized workload is consuming greater than the threshold amount of bandwidth.

As used herein, the term “tag” refers to an indication, such as a label, bit, bit string, executable code, marker, script, flag, or other data that is indicative of a particular condition or conditions. The tag can, for example, include executable code inserted into a manifest, such as a scheduling manifest, to mark containerized workloads and/or VCIs running containers executing containerized workloads that are consuming greater than a threshold amount of bandwidth. In some embodiments, the executable code can be stored in a YAML (YAML Ain't Markup Language) file or other suitable configuration file.

In some embodiments, the traffic footprint characterization agent 114 can schedule execution of a container to run a subsequent containerized workload on a VCI (e.g., the VCI 106-2) that does not have a tagged containerized workload running thereon. For example, the traffic footprint characterization agent 114 can selectively schedule deployment of containers and/or execution of containerized workloads such that the containers are deployed on different VCIs 106 than the VCI 106 on which the containerized workload that is consuming greater than the threshold amount of bandwidth is running (e.g., away from the VCI that has the containerized workload that is consuming greater than the threshold amount of bandwidth). The traffic footprint characterization agent 114 can subsequently execute containerized workloads on containers that are deployed on different VCIs 106 than the VCI 106 on which the containerized workload that is consuming greater than the threshold amount of bandwidth is running. Additional examples of the traffic footprint characterization agent 114 are illustrated and described in more detail with respect to FIGS. 2 and 3, herein.

FIG. 2 is a diagram of a simplified system 200 for traffic footprint characterization according to a number of embodiments of the present disclosure. The system 200 can include a pool of computing resources 216, a plurality of VCIs 206-1, 206-2, . . . , 206-N, a traffic footprint characterization agent 214, and/or a hypervisor 204. The traffic footprint characterization agent 214 can, in some embodiments, be analogous to the traffic footprint characterization agent 114 illustrated in FIG. 1, herein.

The system 200 can include additional or fewer components than illustrated to perform the various functions described herein. In some embodiments, the VCIs 206-1, 206-2, . . . , 206-N, and/or the traffic footprint characterization agent 214 can be deployed on the hypervisor 204 and can be provisioned with the pool of computing resources 216; however, embodiments are not so limited and, in some embodiments, the traffic footprint characterization agent 214 can be deployed on one or more VCIs, for example, as a distributed agent. This latter embodiment is described in more detail in connection with FIGS. 3A, 3B, and 3C, herein.

The pool of computing resources 216 can include physical computing resources used in a software defined data center, for example, compute, storage, and network physical resources such as processors, memory, and network appliances. The VCIs 206-1, 206-2, . . . , 206-N, can be provisioned with computing resources to enable functionality of the VCIs 206-1, 206-2, . . . , 206-N. In some embodiments, the system 200 can include a combination of hardware and program instructions that are configured to provision the VCIs 206-1, 206-2, . . . , 206-N using a pool of computing resources in a software defined data center.

In some embodiments, the traffic footprint characterization agent 214 can assign host the containers 220-1, . . . , 220-N to the VCIs 206. For example, when a new container 220 is generated to, for example, run a containerized workload 222-1, . . . , 222-N, the traffic footprint characterization agent 214 can select a VCI (e.g., VCI 206-1) on which to deploy the container (e.g., the container 220-1). As part of selecting the VCI 206 on which to deploy the container 220, the traffic footprint characterization agent 214 can monitor network traffic (e.g., containerized workloads 222) originating from containers 220 deployed on the VCIs 206 to determine that a flow(s) originating from a container (e.g., the container 220-2) deployed on a VCI (e.g., the VCI 206-2) has certain characteristics associated therewith. Examples of the characteristics associated with the network traffic originating from the containers 220 can include an amount of time the network traffic has run or will run, an amount of bandwidth consumed by the network traffic, an amount of data associated with the network traffic, and whether the network traffic corresponds to an elephant flow or a mouse flow, among other characteristics. For example, the data traffic can be classified based on the size of flows corresponding to the data traffic. Herein, data traffic corresponding to a small flow, which may be referred to as a “mouse flow” or “mice flows” in the plural can include flows that are approximately 10 kilobytes in size or less, while data traffic corresponding to a large flow, which may be referred to as an “elephant flow” or “elephant flows in the plural can include flows that are approximately 10 kilobytes in size or greater. In some embodiments, the network traffic monitored by the traffic footprint characterization agent 214 can include network traffic corresponding to execution of containerized workloads on the containers 220.

The traffic footprint characterization agent 214 can, in some embodiments, assign a tag (e.g., an indication) to a containerized workload 222 based, at least in part, on the determination that the flow corresponding to the containerized workload 222 originating from the computing instance (e.g., a VCI 206) exhibits one or more of the characteristics above (e.g., includes greater than the threshold quantity of data, consumes greater than a threshold amount of bandwidth, etc.). For example, the traffic footprint characterization agent 214 can assign a tag (e.g. generate and/or store information that identifies) containerized workloads 222 that exhibit particular characteristics, such as consumption of relatively large amounts of bandwidth, relatively large amounts of data used in execution, and/or an amount of time for which the containerized workload 222 has been running or will be running. The traffic footprint characterization agent 214 can schedule execution of containers 220 to run subsequent containerized workloads 222 based on the tags. For example, the traffic footprint characterization engine 214 can schedule execution of containers and/or containerized workloads on VCIs 206 that do not have containers 220 running thereon that are executing containerized workloads 222 that have tags associated therewith.

FIGS. 3A-3C show various system configurations for traffic footprint characterization according to the present disclosure. Although the configurations shown in FIGS. 3A-3C make particular reference to virtual computing clusters and software defined data centers, it will be appreciated that aspects of the present disclosure could be performed using a bare metal server. A bare metal server is a single tenant physical server. For example, the traffic footprint characterization agent could, in some embodiments, be deployed or executed on a bare metal server to achieve traffic footprint characterization as described herein.

FIG. 3A is a diagram of a system including a scheduling agent 307, virtual computing instances 306, and hypervisors 304 for traffic footprint characterization according to the present disclosure. As shown in FIG. 3A, the system includes a scheduling agent 307, a plurality of VCIs 306-1, . . . , 306-N, and a plurality of hypervisors 304-1, . . . , 304-M. The plurality of VCIs 306 can include respective containers 320, which can run respective containerized workloads 322 (e.g., containerized workloads 322_{X}-1, . . . , 322_{X}-M, 322_{Y}, 322_{Z}, etc.). In addition, the respective VCIs 306 can include respective scheduling sub-agents 326-1, 326-2, . . . , 326-N.

Non-limiting examples of scheduling sub-agents 326 can include KUBELETS®, among other scheduling sub-agents, that may be deployed on the VCIs 306 to communicate resource information, network state information, and/or traffic footprint information (e.g., information corresponding to tagged containerized workloads 322) corresponding to the VCIs 306 and/or hypervisors 304 on which they are deployed to the traffic footprint characterization agent(s) 314 and/or the scheduling agent 307. The VCIs 306 and hypervisors 304 illustrated in FIGS. 3A and 3B can, in some embodiments, be part of a cluster 305 (e.g., a virtual computing cluster (VCC)). Although shown as separate agents, in some embodiments, such as the embodiments described in connection with FIG. 3B, herein, the scheduling agent 307 can be included within the traffic footprint characterization agent 314.

As shown in FIG. 3A, the cluster 305 (e.g., the VCC) can include a plurality of virtual computing instances (VCIs) 306 provisioned with a pool of computing resources (e.g., processing resources 108 and/or memory resources 110 illustrated in FIG. 1, herein) and ultimately executed by hardware. In some embodiments, at least a first VCI (e.g., the VCI 306-1) is deployed on a first hypervisor (e.g., the hypervisor 304-1) of the cluster 305 and at least a second VCI (e.g., the VCI 306-2) is deployed on a second hypervisor (e.g., the hypervisor 304-M) of the cluster 305. The VCIs 306 can include containers 320.

Although the VCI 306-1 is shown as having a plurality of containers deployed thereon (e.g., the containers 320_{X}-1, . . . , 320_{X}-N) and the other VCIs 306-2 and 306-N are illustrated as having a single container deployed thereon (e.g., the containers 320_{Y} and 320_{Z}), embodiments are not so limited and the VCIs 306 can include a greater or lesser number of containers based on the resources available to the respective VCIs 306. The containers 320 can have one or more containerized workloads (e.g., microservices) running thereon, as described in more detail below.

The containers 320 can be configured to run containerized workloads 322 as part of providing an application to be executed by the traffic footprint characterization agent(s) 314, the scheduling agent 307 and/or the VCIs 306. As described above, containerized workloads 322 can include instructions corresponding to modularized, containerized portions of an application. Containers 320 that are running containerized workloads 322 can be “short lived” due to the nature of the containerized workloads. For example, the containers 320 that are running containerized workloads 322 may only be in existence for a short period (e.g., seconds to minutes) of time, and may be destroyed after the containerized workload 322 running thereon is no longer useful or needed. In some embodiments, the containers 320 that are running containerized workloads 322 may be destroyed after the containerized workload 322 running thereon has been executed and/or the application that was using the containerized workload 322 has been executed.

As a result, the containerized workloads 322 can, in some embodiments, affect overall system latency if execution of the containerized workloads 322 are not scheduled effectively. In some approaches, containerized workloads 322 may be scheduled (e.g., by the scheduling agent 307) based solely on resource consumption associated with the VCIs 306 on which the containers 320 to run the containerized workloads 322 are deployed, however, by only taking the resource consumption of the VCIs 306 into account when scheduling execution of the containerized workloads 322, other network parameters that can affect the latency of the containerized workloads 322 (or the application that depends on the microservices) may not be taken into account when scheduling execution of the microservices, which can result in degraded system and/or application performance. For example, an amount of bandwidth or processing resources consumed in execution of containerized workloads 322 can affect the performance of the system and/or application. By monitoring and/or tagging containerized workloads 322 in response to a determination that the containerized workloads 322 are consuming greater than a threshold amount of resources, and scheduling subsequent containers 320 and/or containerized workloads 322 away from the tagged containerized workloads 322, embodiments herein can alleviate or mitigate effects that can lead to degraded system and/or application performance in comparison to approaches in which containerized workloads 322 are not monitored and/or tagged.

The hypervisors 304-1, . . . , 304-M can include traffic footprint characterization agents 314-1, . . . , 314-N and interfaces 329-1, . . . , 329-N. The traffic footprint characterization agents 314 can periodically or continually collect information such as traffic flow characteristics corresponding to execution of containerized workloads 322 on containers 320 deployed in the VCC 305. As described above, the traffic flow characteristics can include bandwidth consumption associated with containerized workloads 322, an amount of time it has taken or will take to execute containerized workloads 322, an amount of data associated with the containerized workloads 322, etc. Based on the collected information corresponding to the traffic flow characteristics of the containerized workloads 322, the traffic footprint characterization agent 314 can tag particular containerized workloads 322 and cause subsequently executed containerized workloads to be deployed on containers 320 and/or VCIs 306 that are not encumbered by tagged containerized workloads.

In some embodiments, a first traffic footprint characterization agent 314-1 may be deployed on the first hypervisor 304-1. The first traffic footprint characterization agent 314-1 may be configured to monitor traffic flows in the cluster 305 for containerized workloads 322 executed on containers 322 in the cluster 305. For example, the first traffic footprint characterization traffic footprint characterization agent 314-1 can be configured to monitor traffic flows for the first VCI 306-1 and tag containerized workloads (e.g., the containerized workloads 322_{X}-1 to 322_{X}-M) executed by containers (e.g., the containers 320_{X}-1 to 322_{X}-M) executed on the first VCI 306-1. An N^{th} traffic footprint characterization agent 314-N can be deployed on the second hypervisor 304-M. The N^{th} traffic footprint characterization agent 314-N can be configured to monitor traffic flows for the second through N^{th} VCIs 306-2 to 306-N and tag containerized workloads (e.g., the containerized workloads 322_{Y} to 322_{Z}) executed by containers (e.g., the containers 320_{Y} to 322_{Z}) executed on the second through Nth VCIs 306-2 to 306-N.

In a non-limiting example, the traffic footprint characterization agent 314 can monitor traffic flows corresponding to containerized workloads 322 in the VCC 305 and determine that a containerized workload (e.g., the containerized workload 322_{X}-1) is exhibiting relatively heavy traffic flow characteristics (e.g., the containerized workload 322_{X}-1 is consuming greater than a threshold amount of bandwidth, will be executed for greater than a threshold period of time, is exhibiting behavior indicative of an elephant flow, etc.). The traffic footprint characterization agent 314 can tag the containerized workload 322_{X}-1 to indicate that the containerized workload 322_{X}-1 is exhibiting such characteristics. As discussed above, tagging the containerized workload 322_{X}-1 can include modifying a configuration file (e.g., a YAML file) in a manifest that is used by the traffic footprint characterization agent 314 and/or the scheduling agent 307) to schedule deployment of containers 320 and/or to schedule execution of containerized workloads 322 in the VCC 305.

Continuing with the above non-limiting example, when a new containerized workload (e.g., the containerized workload 322_{Y}) is to be executed, the traffic footprint characterization agent 314 (and/or the scheduling agent 307) can cause the containerized workload 322_{Y} to be executed on a container (e.g., the container 320_{Y}) that is in a different location in the VCC 305 than the container (e.g., the container 320_{X}) on which the tagged containerized workload 322_{X}-1 is being executed. As used herein, “a different location in the VCC” refers to something that is deployed or running on a different VCI or hypervisor. For example, the containerized workload 322_{Y} is in a different location in the VCC 305 than the containerized workload 322_{X}-1, because the workload 322_{Y} is running on a different VCI (e.g., the VCI 306-2) than the containerized workload 322_{X}-1, which is running on the VCI 306-1.

Although the above example describes scheduling execution of containerized workloads 322 on containers 320 that are in a different location than containerized workloads 322 that are tagged by the traffic footprint characterization agent 314, embodiments are not so limited and the traffic footprint characterization agent 314 can cause containers 320 to be deployed to execute containerized workloads 322 on VCIs 306 that are different than a VCI 306 on which the tagged containerized workload is executed. For example, continuing with the above example, the traffic footprint characterization agent 314 can cause a container (e.g., the container 320_{Y}) to be deployed on the VCI 306-2 in response to a determination that a tagged containerized workload (e.g., the containerized workload 322_{X}-1) is being executed on a container (e.g., the container 320_{X}-1) deployed on the VCI 306-1.

By scheduling containers 320 and/or containerized workloads 322 in a different location (e.g., “away” from) than tagged containers 320 and/or containerized workloads 322, the traffic footprint characterization agent 314 can control traffic flow deployment in the VCC 305 in a manner that improves the performance of the VCIs 306, the containers 320, the containerized workloads 322, and/or the VCC 305. For example, by scheduling deployment of containers 320 and/or containerized workloads 322 away from tagged containers 320 and/or containerized workloads 322, containers 320 and/or containerized workloads 322 that are scheduled by the traffic footprint characterization agent 314 can enjoy access to greater resources than those containers 320 and/or containerized workloads 322 that are scheduled for deployment on a same VCI 306 or container 320 (e.g., “near”) as containerized workloads 322 that are consuming a relatively large amount of resources.

In some embodiments, the scheduling agent 307 can access the information corresponding to the containerized workloads 322 that is generated and/or stored by the traffic footprint characterization agent 314 as part of an operation to schedule container 320 deployment and/or containerized workload 322 execution. For example, the scheduling agent 307 can receive information from the traffic footprint characterization agent 314 that indicates whether flows in the cluster 305 are short lived (e.g., correspond to microservices and running on containers that exist for second to minutes) or are “long lived,” (e.g., high volume flows running on containers that exist for minutes or longer). The information can be based on a byte count and/or a time threshold associated with execution of a containerized workload 322 or application. For example, flows that exceed a certain quantity of bytes can be classified as long lived, while flows that do not exceed the certain quantity of bytes can be classified as short lived. In the alternative or in addition, containers 322 that are in existence for seconds to minutes can be classified as short lived, while containers that are in existence for minutes or longer can be classified as long lived. In some embodiments, the information can include one or more tags generated by the traffic footprint characterization agent 314 that indicate that particular containers 320 and/or containerized workloads 322 include flows that are long lived.

In addition to, or in the alternative, the traffic footprint characterization agents 314 can collect statistics corresponding to interference from non-container VCIs co-located on hypervisors 304 where VCIs 306 are running a container 320. For example, in public cloud deployments, the traffic footprint characterization agents 314 can detect interference from non-containerized resources that may be consuming VCI 306 resources that the scheduling agent 307 may not be able to detect. In some embodiments, non-container VCIs are VCIs that do not have any containers deployed thereon and are instead running traditional workloads. By using this information, container and/or containerized workload scheduling may be improved in comparison to approaches in which a scheduling agent 307 is unable to detect interference from non-containerized resources running on the VCIs 306. Non-containerized workloads can include traditional workloads such as public cloud, hypervisor deployed workloads and/or VCIs deployed on shared hypervisors.

If, as in the example shown in FIG. 3A, the cluster 305 includes a plurality of hypervisors 304-1, . . . , 304-M and there are more long lived heavy flows running inside the container(s) 320_{X}-1, . . . , 320_{X}-M on the VCI 306-1 than there are running on the container(s) 320B on the VCI 306-2, the quantity of tags assigned by the traffic footprint characterization agents 314 will be higher for the VCI 306-1 than for the VCI 306-2. In this example, the traffic footprint characterization agent 314 and/or the scheduling agent 307 can cause a container (e.g., the container 320_{Y}) to be deployed on the VCI 306-2 to execute a containerized workload (e.g., the containerized workload 322_{X}-1).

The traffic footprint characterization agent 314 can use the determined information (e.g., the byte counts, time thresholds, or other containerized workload characteristics described above) to generate tags for the VCIs 306, the containers 320, and/or the containerized workloads 322. These tags can, as described above, be used by the traffic footprint agent(s) 314 and/or the scheduling agent 307 to schedule subsequent containerized workloads 322 and/or containers 320 on which to run containerized workloads 322 away from containers 320, VCIs 306, and/or containerized workloads 322 that have been tagged as part of traffic footprint characterization according to the disclosure.

In some embodiments, when a cluster 305 is generated, the traffic footprint characterization agents 314-1, . . . , 314-N on the hypervisors 304-1, . . . , 304-M can periodically (or continually) collect information (e.g., data and/or statistics) corresponding to the network traffic footprint incurred as a result of containerized workloads 322 running in the VCC, as described above, and tag containerized workloads 322 that are exhibiting certain characteristics. The traffic footprint characterization agents 314 can forward the information and/or the tags to the scheduling sub-agents 326-1, . . . , 326-N on the VCIs 306. In some embodiments, the traffic footprint characterization agents 314 can periodically forward the information and/or tags at set or configurable time intervals. In one non-limiting example, the traffic footprint characterization agents 314 can forward the information and/or tags to the scheduling sub-agents 326 every few or tens of milliseconds (e.g., every 30 milliseconds, etc.). Embodiments are not so limited, however, and in some embodiments, the traffic footprint characterization agents 314 can forward the information and/or tags to the scheduling sub-agents 326 in response to a detection that a threshold change has occurred in the information and/or tags since the last information and/or scores were sent to the scheduling sub-agents 326.

The traffic footprint characterization agents 314 can advertise or forward the information and/or tags to the scheduling agent 307. In some embodiments, the traffic footprint characterization agents 314 can advertise the information and/or tags to the scheduling agent 307 via an application programming interface (API) call, or the scheduling sub-agents 326 can forward the information and/or tags to the scheduling agent 307 periodically or in response to receipt of the information and/or tags from the traffic footprint characterization agents 314.

If a new container 320 is to be created, the traffic footprint characterization agents 314 and/or the scheduling agent 307 can determine on which VCI 306 to schedule the container 320 deployment based on resources available to the VCIs 306 in addition to the tags. By including the tags in the calculus performed by the scheduling agent 307 in addition to the resources available to the VCIs 306 when scheduling deployment of new containers 320, performance of containerized workloads 322 and the applications that depend on the containerized workloads 322 can be improved in comparison to approaches in which only the resources available to the VCIs 306 are taken into account. In addition, because the tags can be asynchronously (e.g., intermittently) sent by the traffic footprint characterization agents 314, delays in network traffic may be further mitigated in comparison to some approaches.

FIG. 3B is another diagram of a system including a traffic footprint characterization agent 314, virtual computing instances 306, and hypervisors 304 for traffic footprint characterization according to the present disclosure. As shown in FIG. 3B, the system, which can be a virtual computing cluster (VCC) 305, includes a traffic footprint characterization agent 314, a plurality of VCIs 306-1, 306-2, . . . , 306-N, and a plurality of hypervisors 304-1, . . . , 304-M. The plurality of VCIs 306 can include respective containers 320, which can run respective containerized workloads 322 (e.g., containerized workloads 322_{X}-1, . . . , 322_{X}-M, 322_{Y}, 322_{Z}, etc.). In addition, the respective VCIs 306 can include respective scheduling sub-agents 326-1, 326-2, . . . , 326-N. In contrast to the embodiments shown in FIG. 3A, in the embodiments illustrated in FIG. 3B, the traffic footprint characterization agent 314 may be centrally deployed in the VCC 305, which may allow for the traffic footprint characterization agent 314 to monitor all traffic flows in the VCC 305, as opposed to traffic flows running on VCIs 306 deployed on the hypervisor 304 on which the traffic footprint characterization agents 314 are running as shown in FIG. 3A.

In some embodiments, the VCC 305 can include a traffic footprint characterization agent 314 that can be configured to assign and/or store tags to the containerized workloads 322 based on characteristics of traffic flows associated with the containerized workloads 322. As described above, the tags can correspond to an amount of bandwidth consumed by the containerized workloads 322, an amount of time for which the containerized workloads 322 will be executed, and amount of data associated with the containerized workloads 322, etc. The traffic footprint characterization agent 314 can cause containers 320 to be deployed on the VCIs 306 and/or can schedule execution of containerized workloads 322 on the containers 320 based, at least in part, on the tags. For example, in the embodiments shown in FIG. 3B, the traffic footprint characterization agent 314 can perform the functionalities of a scheduling agent, such as the scheduling agent 307 illustrated in FIG. 3A, in addition to monitoring containerized workloads 322 and tagging the containerized workloads 322 based on their respective traffic flow characteristics. The scheduling sub-agents 326-1, . . . , 326-N can be used in conjunction with the traffic footprint characterization agent 314 to cause containers 320 to be deployed on the VCIs 306 and/or can schedule execution of containerized workloads 322 on the containers 320 based, at least in part, on the tags.

FIG. 3C is another diagram of a system including a scheduling agent 307, virtual computing instances 306, and hypervisors 304 for traffic footprint characterization according to the present disclosure. As shown in FIG. 3C, the system, which can be a virtual computing cluster (VCC) 305, includes a scheduling agent 307, a plurality of VCIs 306-1, 306-2, . . . , 306-N, and a plurality of hypervisors 304-1, . . . , 304-M. The plurality of VCIs 306 can include respective containers 320, which can run respective containerized workloads 322 (e.g., containerized workloads 322_{X}-1, . . . , 322_{X}-M, 322_{Y}, 322_{Z}, etc.). In addition, the respective VCIs 306 can include respective scheduling sub-agents 326-1, 326-2, . . . , 326-N and traffic characterization agents 314-1, . . . , 314-N.

In some embodiments, the VCC 305 can include a scheduling agent 307 that can be configured to receive, from a first traffic footprint characterization 314-1 deployed on the first VCI 306-1, tags and/or other information corresponding to containerized workloads 322_{X}-1, . . . , 322_{X}-M running on containers 320 deployed on the first VCI 306-1. The scheduling agent 307 can also receive, from a second traffic footprint characterization 314-2 deployed on the second VCI 306-2, tags and/or other information corresponding to containerized workloads 322_{Y} running on containers 320 deployed on the second VCI 306-2. The scheduling agent 307 can be further configured to cause a container 320 to be deployed on at least one of the first VCI 306-1 and the second VCI 306-2 based, at least in part, on the tags and/or other information corresponding to the containerized workloads 322.

As described above, the tags can include information corresponding to data traffic in the VCC 305. The data traffic can be classified based on the size of flows corresponding to the data traffic. For example, data traffic corresponding to small flows, which may be referred to as “mice flows” can include flows that are approximately 10 kilobytes in size or less, while data traffic corresponding to large flows, which may be referred to as “elephant flows” can include flows that are approximately 10 kilobytes in size or greater. In some embodiments, the traffic footprint characterization agents 314 can analyze data traffic to determine a quantity (e.g., a number) of mice flows and a quantity of elephant flows associated with the VCIs 306. This information can then be used by the traffic footprint characterization agents 314 to tag the containerized workloads 322 and, in some embodiments, schedule deployment of containers 320 to run subsequent containerized workloads 322. In order to identify the presence of elephant flows, the traffic footprint characterization agent 314 can, in some embodiments, be provided with access to a kernel data path into userspace.

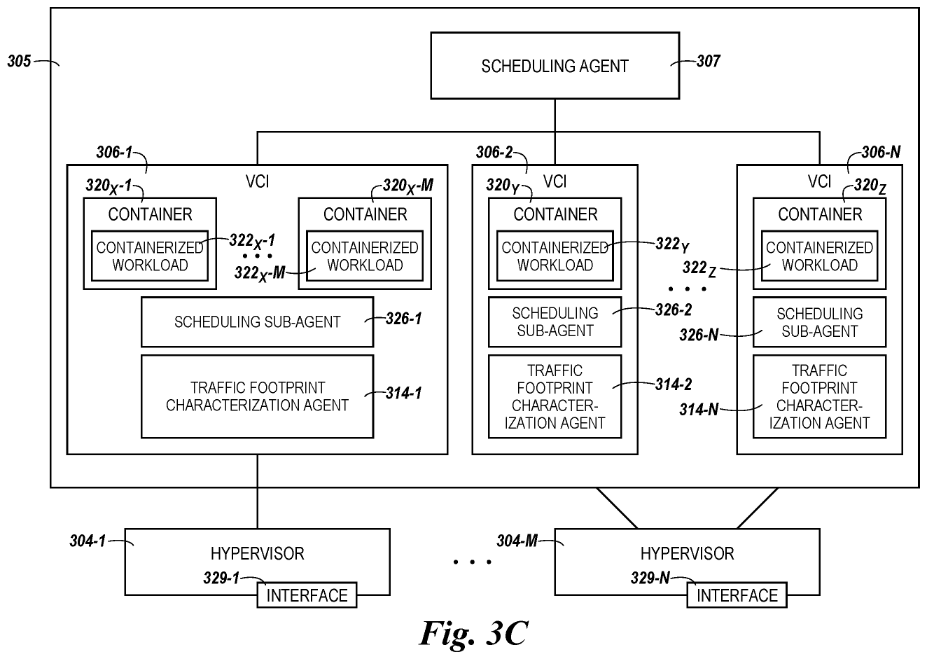

FIG. 4A is a flow diagram representing a method 440 for traffic footprint characterization according to the present disclosure. At block 442, the method 440 can include monitoring containerized workloads originating from a first virtual computing instance (VCI). The VCI can be analogous to at least one of the VCIs 106/206/306 illustrated in FIGS. 1 and 3A-3C, herein. The containerized workload can be analogous to at least one of the containerized workloads 222/322 illustrated in FIGS. 2 and 3A-3C, herein. In some embodiments, the containerized workloads can be monitored by a traffic footprint characterization agent, such as the traffic footprint characterization agent 114/214/314 illustrated in FIGS. 1 and 3A-3C, herein.

At block 444, the method 440 can include determining that a containerized workload originating from the first VCI consumes greater than a threshold amount of bandwidth. In some embodiments, the method 440 can include determining that the containerized workload corresponds to an elephant flow that may be long lived and/or may include greater than a threshold quantity of data. The containerized workload can correspond to a fine-grained service that is executed as part of an application deployed in a software defined data center, as described above.

At block 446, the method 440 can include tagging the first VCI in response to determining that the containerized workload consumes greater than the threshold amount of bandwidth. In some embodiments, the tag can be stored as an entry in a manifest (e.g., a scheduling manifest). The manifest can be a configuration file such as a YAML file and the entry can include executable code and/or one or more scripts that identify the VCI as a VCI from which a containerized workload that consumes greater than the threshold amount of bandwidth originates. Embodiments are not limited to tagging a VCI, as described above, however, and in some embodiments, generating tagging can further include tagging network traffic that corresponds to the containerized workload and/or the container on which the containerized workload is running.

In some embodiments, the method 440 can further include scheduling execution of a subsequent containerized workload on a second VCI based, at least in part, on the tag, as described above in connection with FIGS. 3A-3C. Scheduling execution of the subsequent containerized workload can include generating a container to execute a subsequent containerized workload based on determining that the containerized workload originating from the first VCI consumes greater than a threshold amount of bandwidth. For example, the traffic footprint characterization agent and/or a scheduling agent can schedule deployment of a container on a VCI to execute the subsequently executed containerized workload.

FIG. 4B is another flow diagram representing a method 450 for traffic footprint characterization according to the present disclosure. At block 452, the method 450 can include monitoring, via a traffic footprint characterization agent deployed in a virtual computing cluster (VCC), network traffic originating from a container deployed in the VCC. The traffic footprint characterization agent can be analogous to the traffic footprint characterization agent 114/214/314 illustrated in FIGS. 1 and 3A-3C, herein, while the VCC can be analogous to the VCC 305 illustrated in FIGS. 3A-3C, herein. In some embodiments, the network traffic can include traffic corresponding to containerized workloads (e.g., the containerized workloads 222/322 illustrated in FIGS. 2 and 3A-3C, herein).

At block 454, the method 450 can include determining that a flow corresponding to a containerized workload originating from the container includes greater than a threshold quantity of data. In some embodiments, the method 450 can include determining that the containerized workload corresponds to an elephant flow that may be long lived and/or may include greater than a threshold quantity of data. The containerized workload can correspond to a fine-grained service that is executed as part of an application deployed in a software defined data center, as described above.

At block 456, the method 450 can include assigning, by the traffic footprint characterization agent, an indication to the containerized workload based, at least in part, on the determination that the flow corresponding to the containerized workload originating from the container includes greater than the threshold quantity of data. The indication can include a tag, which can be included in a scheduling manifest that is used as part of containerized workload scheduling in the VCC, as described above. In some embodiments, assigning the indication can include generating an entry corresponding to the indication in a manifest associated with the traffic footprint characterization agent. As described above, the entry can be used by the traffic footprint characterization agent to schedule a subsequent containerized workload.

In some embodiments, the method 450 can include scheduling, via the traffic footprint characterization agent, execution of a subsequent containerized workload on a container different than the container originating the flow corresponding to the containerized workload that includes greater than the threshold quantity of data based, at least in part, on the indication. For example, in order to manage traffic flows and resource consumption in the VCC, the traffic footprint characterization agent can schedule execution of subsequent containerized workloads “away” from containers (or VCIs) that are already executing containerized workloads that have the indication (e.g., tagged containerized workloads) assigned thereto.

The method 450 can, in some embodiments, further include determining that the container is deployed on a first virtual computing instance (VCI) in the VCC and/or generating, by the traffic footprint characterization agent, a container to execute a subsequent containerized workload on a second VCI in the VCC based, at least in part, on the indication. For example, as described above in connection with FIGS. 3A-3C, the traffic footprint characterization agent can cause a new container to be deployed to execute a containerized workload on a VCI that is not encumbered with containers that are running containerized workloads that have the indication assigned thereto. Embodiments are not so limited, however, and in some embodiments the method 450 can include determining that the container is deployed on a first hypervisor in the VCC and/or generating, by the traffic footprint characterization agent, a container to execute a subsequent containerized workload on a second hypervisor in the VCC based, at least in part, on the indication.

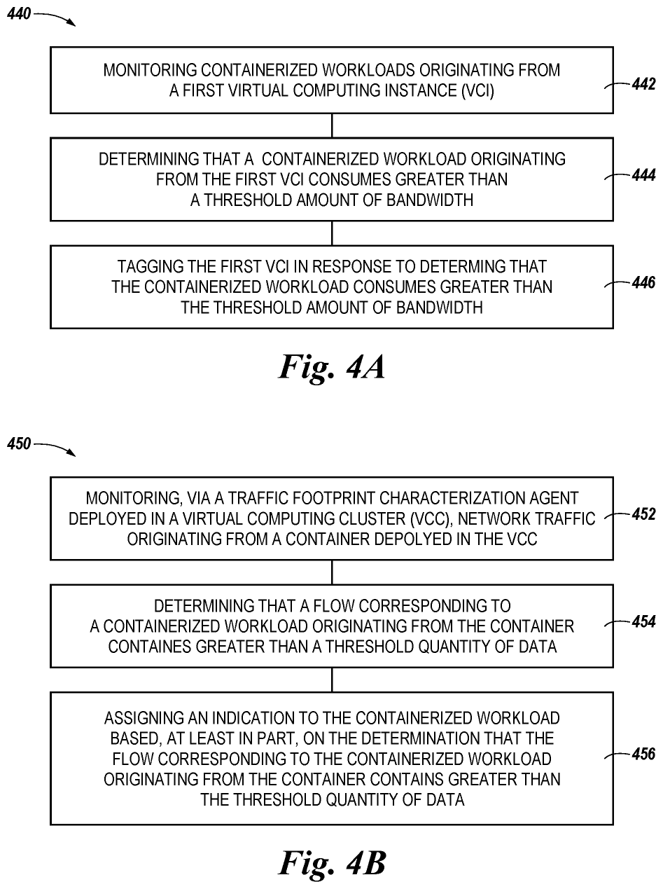

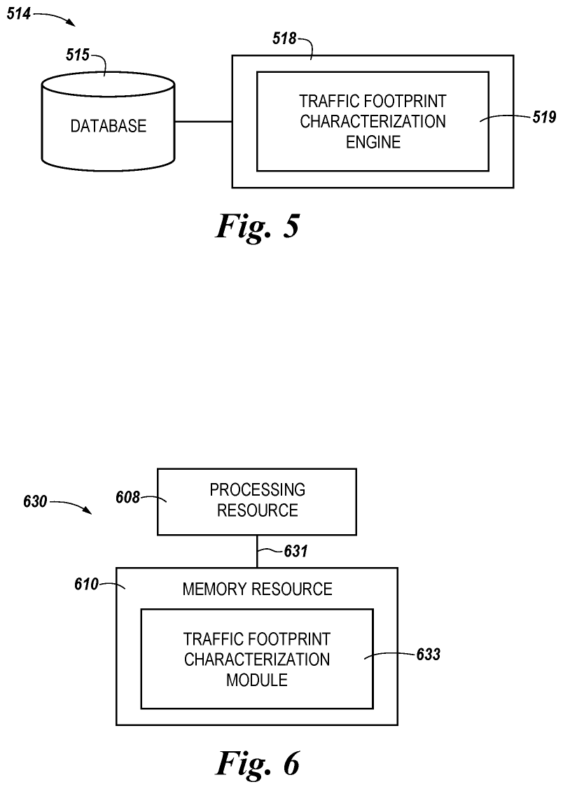

FIG. 5 is a diagram of an apparatus for traffic footprint characterization according to the present disclosure. The apparatus 514 can include a database 515, a subsystem 518, and/or a number of engines, for example traffic footprint characterization engine 519, and can be in communication with the database 515 via a communication link. The apparatus 514 can include additional or fewer engines than illustrated to perform the various functions described herein. The apparatus 514 can represent program instructions and/or hardware of a machine (e.g., machine 630 as referenced in FIG. 6, etc.). As used herein, an “engine” can include program instructions and/or hardware, but at least includes hardware. Hardware is a physical component of a machine that enables it to perform a function. Examples of hardware can include a processing resource, a memory resource, a logic gate, etc. In some embodiments, the apparatus 514 can be analogous to the traffic footprint characterization agent 114 illustrated and described in connection with FIG. 1, herein.

The engines (e.g., the traffic footprint characterization engine 519) can include a combination of hardware and program instructions that are configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the traffic footprint characterization engine 519 can include a combination of hardware and program instructions that can be configured to monitor traffic flows corresponding to execution of containerized workloads in, for example, a virtual computing cluster or software defined data center. The traffic footprint characterization engine 519 can tag traffic flows that exhibit particular characteristics (e.g., flows with greater than a threshold bandwidth consumption, elephant flows, flows greater than a threshold quantity of data associated therewith, etc.) and cause subsequently executed containerized workloads to be scheduled on containers and/or VCIs that do not have tagged traffic flows (or that have less tagged traffic flows than other containers or VCIs), as described above.

For example, the traffic footprint characterization engine 519 can include a combination of hardware and program instructions that can be configured to monitor traffic corresponding to containerized workloads originating from a plurality of containers deployed in a software defined data center and assign respective tags to containerized workloads that have greater than a threshold quantity of data associated therewith. In some embodiments, the traffic footprint characterization engine 519 can further include a combination of hardware and program instructions that can be configured to schedule deployment of a container to execute a new containerized workload based, at least in part, on the respective tags.

The traffic footprint characterization engine 519 can further include a combination of hardware and program instructions that can be configured to schedule deployment of a container to execute a new containerized workload on a virtual computing instance deployed in the VCC that has fewer than a threshold quantity of tagged containerized workloads running thereon. Embodiments are not so limited, however, and in some embodiments, the traffic footprint characterization engine 519 can further include a combination of hardware and program instructions that can be configured to schedule deployment of a container to execute a new containerized workload on a hypervisor deployed in the VCC that has fewer than a threshold quantity of tagged containerized workloads running thereon. Further, in some embodiments, the traffic footprint characterization engine 519 can further include a combination of hardware and program instructions that can be configured to schedule deployment of a container to execute a new containerized workload on a virtual computing instance (VCI) running on a hypervisor deployed in the VCC that has fewer than a threshold quantity of VCIs running containers executing tagged containerized workloads.

As described above, in some embodiments, the traffic footprint characterization engine 519 can further include a combination of hardware and program instructions that can be configured to generate entries corresponding to the respective tags in a manifest associated with the traffic footprint characterization agent. The manifest can be a configuration file such as a YAML file and the entry can include executable code and/or one or more scripts that identify containerized workload as a containerized workload that consumes greater than the threshold amount of bandwidth, has greater than threshold quantity of data associated therewith, corresponds to an elephant flow, etc.

FIG. 6 is a diagram of a machine for traffic footprint characterization according to the present disclosure. The machine 630 can utilize software, hardware, firmware, and/or logic to perform a number of functions. The machine 630 can be a combination of hardware and program instructions configured to perform a number of functions (e.g., actions). The hardware, for example, can include a number of processing resources 608 and a number of memory resources 610, such as a machine-readable medium (MRM) or other memory resources 610. The memory resources 610 can be internal and/or external to the machine 630 (e.g., the machine 630 can include internal memory resources and have access to external memory resources). In some embodiments, the machine 630 can be a VCI, for example, the machine 630 can be a server. The program instructions (e.g., machine-readable instructions (MM)) can include instructions stored on the MRM to implement a particular function (e.g., actions related to traffic footprint characterization as described herein). The set of Mill can be executable by one or more of the processing resources 608. The memory resources 610 can be coupled to the machine 630 in a wired and/or wireless manner. For example, the memory resources 610 can be an internal memory, a portable memory, a portable disk, and/or a memory associated with another resource, e.g., enabling Mill to be transferred and/or executed across a network such as the Internet. As used herein, a “module” can include program instructions and/or hardware, but at least includes program instructions.

Memory resources 610 can be non-transitory and can include volatile and/or non-volatile memory. Volatile memory can include memory that depends upon power to store information, such as various types of dynamic random-access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAIVI), magnetic memory, optical memory, and/or a solid-state drive (SSD), etc., as well as other types of machine-readable media.

The processing resources 608 can be coupled to the memory resources 610 via a communication path 631. The communication path 631 can be local or remote to the machine 630. Examples of a local communication path 631 can include an electronic bus internal to a machine, where the memory resources 610 are in communication with the processing resources 608 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 631 can be such that the memory resources 610 are remote from the processing resources 608, such as in a network connection between the memory resources 610 and the processing resources 608. That is, the communication path 631 can be a network connection. Examples of such a network connection can include a local area network (LAN), wide area network (WAN), personal area network (PAN), and the Internet, among others.

As shown in FIG. 6, the MRI stored in the memory resources 610 can be segmented into a number of modules, e.g., 633, that when executed by the processing resource(s) 608, can perform a number of functions. As used herein a module includes a set of instructions included to perform a particular task or action. The module(s) 633 can be sub-modules of other modules. Examples are not limited to the specific module(s) 633 illustrated in FIG. 6.

The module(s) 633 can include program instructions and/or a combination of hardware and program instructions that, when executed by a processing resource 608, can function as a corresponding engine as described with respect to FIG. 5. For example, the traffic footprint characterization module 633 can include program instructions and/or a combination of hardware and program instructions that, when executed by a processing resource 608, can function as the traffic footprint characterization engine 519.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for traffic footprint characterization, comprising:
monitoring containerized workloads originating from a first virtual computing instance (VCI);
determining that a containerized workload originating from the first VCI consumes greater than a threshold amount of bandwidth; and
tagging the first VCI in response to determining that the containerized workload consumes greater than the threshold amount of bandwidth.

2. The method of claim 1, further comprising scheduling execution of a subsequent containerized workload on a second VCI based, at least in part, on the tag.

3. The method of claim 1, further comprising generating a container to execute a subsequent containerized workload based on determining that the containerized workload originating from the first VCI consumes greater than a threshold amount of bandwidth.

4. The method of claim 1, further comprising generating an entry in a manifest associated with a containerized workload scheduling agent, wherein the entry corresponds to the tag.

5. The method of claim 1, wherein tagging the first VCI further comprises tagging network traffic corresponding to the containerized workload originating from the first VCI.

6. The method of claim 1, wherein the containerized workload corresponds to a fine-grained service originating from the first VCI as part of an application deployed in a software defined data center.

7. A method for traffic footprint characterization, comprising:
monitoring, via a traffic footprint characterization agent deployed in a virtual computing cluster (VCC), network traffic originating from a container deployed in the VCC;
determining that a flow corresponding to a containerized workload originating from the container includes greater than a threshold quantity of data;
assigning, by the traffic footprint characterization agent, an indication to the containerized workload based, at least in part, on the determination that the flow corresponding to the containerized workload originating from the container includes greater than the threshold quantity of data.

8. The method of claim 7, further comprising generating an entry corresponding to the indication in a manifest associated with the traffic footprint characterization agent, wherein the entry is used by the traffic footprint characterization agent to schedule a subsequent containerized workload.

9. The method of claim 7, further comprising scheduling, via the traffic footprint characterization agent, execution of a subsequent containerized workload on a container different than the container originating the flow corresponding to the containerized workload that includes greater than the threshold quantity of data based, at least in part, on the indication.

10. The method of claim 7, wherein the containerized workload corresponds to a fine-grained service originating from the computing instance, and wherein the fine-grained service corresponds to part of a computing application running in a software defined data center.

11. The method of claim 7, further comprising:
determining that the container is deployed on a first virtual computing instance (VCI) in the VCC; and
generating, by the traffic footprint characterization agent, a container to execute a subsequent containerized workload on a second VCI in the VCC based, at least in part, on the indication.

12. The method of claim 7, further comprising:
determining that the container is deployed on a first hypervisor in the VCC; and
generating, by the traffic footprint characterization agent, a container to execute a subsequent containerized workload on a second hypervisor in the VCC based, at least in part, on the indication.

13. The method of claim 7, further comprising assigning, by the traffic footprint characterization agent, the indication to the containerized workload based, at least in part, on a determination that the flow corresponding to the containerized workload originating from the container corresponds to an elephant flow.

14. An apparatus for traffic footprint characterization, comprising:
a traffic footprint characterization agent provisioned with processing resources and ultimately executed by hardware, wherein the traffic footprint characterization agent is configured to:
monitor traffic corresponding to containerized workloads originating from a plurality of containers deployed in a software defined data center;
assign respective tags to containerized workloads that have greater than a threshold quantity of data associated therewith.

15. The apparatus of claim 14, wherein the traffic footprint characterization agent is further configured to schedule deployment of a container to execute a new containerized workload based, at least in part, on the respective tags.

16. The apparatus of claim 14, wherein the traffic footprint characterization agent is further configured to schedule deployment of a container to execute a new containerized workload on a virtual computing instance deployed in the VCC that has fewer than a threshold quantity of tagged containerized workloads running thereon.

17. The apparatus of claim 14, wherein the traffic footprint characterization agent is further configured to schedule deployment of a container to execute a new containerized workload on a hypervisor deployed in the VCC that has fewer than a threshold quantity of tagged containerized workloads running thereon.

18. The apparatus of claim 17, wherein the traffic footprint characterization agent is further configured to schedule deployment of a container to execute a new containerized workload on a virtual computing instance (VCI) running on a hypervisor deployed in the VCC that has fewer than a threshold quantity of VCIs running containers executing tagged containerized workloads.

19. The apparatus of claim 14, wherein the traffic footprint characterization agent is further configured to generate entries corresponding to the respective tags in a manifest associated with the traffic footprint characterization agent.

20. The apparatus of claim 14, wherein the containerized workloads are microservices running as part of execution of an application.

21. A system for traffic footprint characterization, comprising:
a virtual computing cluster (VCC);
a plurality of virtual computing instances (VCIs) deployed within the VCC;
a traffic footprint characterization agent deployed within the VCC that is provisioned with processing resources and ultimately executed by hardware, wherein the traffic footprint characterization agent is configured to:
determine that a containerized workload originating from a container deployed on a first VCI among the plurality of VCIs is to be executed for greater than a threshold period of time;
schedule execution of a subsequent containerized workload on a second container deployed on a second VCI among the plurality of VCIs in response to the determination.

22. The system of claim 21, wherein the traffic footprint characterization agent is configured to tag the containerized workload originating from the container deployed on the first VCI by generating an entry in a manifest associated with the traffic footprint characterization agent, wherein the entry corresponds to the determination that the containerized workload is to be executed for greater than the threshold period of time.

23. The system of claim 21, wherein the containerized workload originating from the container deployed on the first VCI and the subsequently executed containerized workload are microservices running as part of execution of an application executed in the VCC.

24. The system of claim 21, wherein the first VCI is running on a first hypervisor in the VCC and the second VCI is running on a second hypervisor in the VCC.

25. The system of claim 24, wherein the traffic footprint characterization agent is further configured to:
determine that the second VCI has fewer containerized workloads that are to be executed for greater than the threshold period of time associated therewith than the first VCI; and
schedule execution of the subsequent containerized workload on the second container deployed on the second VCI based, at least in part, on the determination that the second VCI has fewer containerized workloads that are to be executed for greater than the threshold period of time associated therewith than the first VCI.

26. The system of claim 24, wherein the traffic footprint characterization agent is further configured to:
determine that the second VCI is running on a hypervisor that has fewer containerized workloads that are to be executed for greater than the threshold period of time associated therewith than a hypervisor on which the first VCI is running; and
schedule execution of the subsequent containerized workload on the second container deployed on the second VCI based, at least in part, on the determination that the second VCI is running on a hypervisor that has fewer containerized workloads that are to be executed for greater than the threshold period of time associated therewith than a hypervisor on which the first VCI is running.

27. A system for traffic footprint characterization, comprising:
a virtual computing cluster (VCC);
a plurality of containers deployed within the VCC;
a traffic footprint characterization agent deployed within the VCC that is provisioned with processing resources and ultimately executed by hardware, wherein the traffic footprint characterization agent is configured to:
determine that an average bandwidth consumed by a containerized workload running on a first container in the VCC exceeds an average traffic flow bandwidth threshold;
deploy a second container within the VCC to execute a subsequent containerized workload based, at least in part, on the determination that the average bandwidth consumed by the containerized workload running on the first container exceeds the average traffic flow bandwidth.

28. The system of claim 27, wherein the traffic footprint characterization agent is configured to tag the containerized workload originating from the container deployed on the first VCI by generating an entry in a manifest associated with the traffic footprint characterization agent, wherein the entry corresponds to the determination that the average bandwidth consumed by the containerized workload running on the first container exceeds the average traffic flow bandwidth.

29. The system of claim 27, wherein the traffic footprint characterization agent is further configured to deploy the second container on a virtual computing instance (VCI) running in the VCC that is different than a VCI running in the VCC on which the first container is deployed.

30. The system of claim 29, wherein the traffic footprint characterization agent is further configured to determine that the VCI on which the second container is to be deployed has fewer containerized workloads that consume greater than the average traffic flow bandwidth than the VCI on which the first container is deployed as part of deployment of the second container.

31. The system of claim 29, wherein the traffic footprint characterization agent is further configured to determine that the VCI on which the second container is to be deployed is running on a hypervisor has fewer containerized workloads that consume greater than the average traffic flow bandwidth associated therewith than a hypervisor on which the VCI on which the first container is deployed as part of deployment of the second container.

32. The system of claim 27, wherein the traffic footprint characterization agent is further configured to deploy the second container on a hypervisor running in the VCC that is different than a hypervisor running in the VCC on which the first container is deployed.
